(19) United States
(12) Patent Application Publication
(10) Pub. No.: US 2018/0203290 A1
(43) Pub. Date: Jul. 19, 2018

(54) LIQUID CRYSTAL PANEL, LIQUID CRYSTAL DISPLAY APPARATUS, AND MANUFACTURING METHOD FOR THE LIQUID CRYSTAL PANEL THEREOF

(71) Applicant: Wuhan China Star Optoelectronics Technology Co., Ltd., Wuhan, Hubei (CN)

(72) Inventors: Xin QIU, Shenzhen, Guangdong (CN); Shihpo CHOU, Shenzhen, Guangdong (CN)

(73) Assignee: Wuhan China Star Optoelectronics Technology Co., Ltd., Wuhan, Hubei (CN)

(21) Appl. No.: 15/301,225

(22) PCT Filed: Jun. 27, 2016
(86) PCT No.: PCT/CN2016/087250

§ 371 Date: Sep. 30, 2016

(30) Foreign Application Priority Data
Jun. 2, 2016 (CN) 201610387776.2

(51) Int. Cl. G02F 1/1335; G02F 1/1333; G02F 1/1339; G06F 3/041

(52) U.S. Cl. CPC G02F 1/133514; G02F 1/133512; G06F 3/0412; G02F 1/1339; G02F 1/13338

(57) ABSTRACT

The present application discloses a liquid crystal panel, includes a CF substrate forms a display and a non-display region; the CF substrate including a plurality of color resist modules and a planarization layer, the plurality of color resist modules is arranged in a matrix within the display region, the planarization layer including a shielding layer and a plurality of the first color resist connected to the shielding layer, the plurality of the first color resist and the color resist modules are alternately arranged in the display region, the shielding layer is covering the plurality of the color resist modules, a conducting polymer is added in the planarization layer; an array substrate includes a grounding pad disposed facing to the non-display region; a conductive particle is added in the sealant and the sealant is connected to the planarization layer and the grounding pad to make the planarization layer connecting to ground.

### CROSS REFERENCE

This application claims the priority of Chinese Patent Application No. 201610387776.2, entitled “LIQUID CRYSTAL PANEL, LIQUID CRYSTAL DISPLAY APPARATUS, AND MANUFACTURING METHOD FOR THE LIQUID CRYSTAL PANEL THEREOF”, filed on Jun. 2, 2016, the disclosure of which is incorporated herein by reference in its entirety.

### FIELD OF THE INVENTION

The present application relates to a display technology field, and more particularly to a liquid crystal panel, a liquid crystal display apparatus, and a manufacturing method for the liquid crystal panel thereof.

### BACKGROUND OF THE INVENTION

In recent years, thin film transistor-liquid crystal display, TFT-LCD has been widely used on mobile phones, computers and other electronic display device. Thin film transistor liquid crystal display includes a liquid crystal panel, the liquid crystal panel includes a color filter substrate, CF Substrate and a thin film transistor array substrate, TFT Substrate, the relative inner side of the substrates have transparent electrodes. A layer of liquid crystal molecules, Liquid Crystal, LC is sandwiching between the two substrates. The liquid crystal panel is used by controlling the electric field oriented of the liquid crystal molecules to change the polarization state of light, and realized the light block or path through by polarizing plate to achieve the purpose of display.

To prevent the influence of the electrostatic charge of the electric field in the liquid crystal panel, it usually set up a transparent planar conductive shielding layer between the color filter substrate and the polarizing plate, and the shielding layer is electrically connected to ground at the side of the thin film transistor array substrate by using the silver adhesive, in order to avoid static electricity mura, and abnormal display. However, the method mentioned above requires the using of the silver adhesive, and the level difference covered by the silver adhesive is large, thus having the risk of fracture, so that the liquid crystal panel may still be damaged by static electricity.

### SUMMARY OF THE INVENTION

The technology problem to be solved by the present application is to provide a liquid crystal panel having a function to protection static electricity.

In addition, a liquid crystal display apparatus adapted the liquid crystal panel is also provided.

Besides, a manufacturing method for the liquid crystal panel are also provided to manufacture the liquid crystal display apparatus.

In order to achieve the purpose mentioned above, the technology approach below is adapted in the embodiment of the present application:

In one aspect, a liquid crystal panel is provided, including:

a color filter substrate forms a display region and a non-display region disposed at the periphery of the display region; the color filter substrate including a plurality of color resist modules and a planarization layer, the plurality of color resist modules is arranged in a matrix within the display region, the planarization layer including a shielding layer and a plurality of the first color resist connected to the shielding layer, the plurality of the first color resist and the plurality of the color resist modules are alternately arranged in the display region, the shielding layer is covering the plurality of the color resist modules, a conducting polymer is added in the planarization layer;

an array substrate disposed opposite to the color filter substrate, the array substrate including a grounding pad disposed facing to the non-display region; and

a sealant connected to the array substrate and the non-display region to seal and hold a liquid crystal layer between the color filter substrate and the array substrate, a conductive particle is added in the sealant and the sealant is connected to the planarization layer and the grounding pad to make the planarization layer connecting to ground.

Wherein each of the color resist modules including a second color resist, a third color resist and a fourth color resist, wherein the second color resist is red color resist, the third color resist is green color resist, the fourth color resist is blue color resist and the plurality of first color resist is white color resist or yellow color resist.

Wherein the shielding layer covered the plurality of the color resist modules and makes the shielding layer covered the planarization layer.

Wherein the conductive polymer c including 3,4-ethylenedioxythiophene, PEDOT.

Wherein the conductive particles including gold balls and/or copper particle.

Wherein a touch sensor is integrated on the array substrate to realize the touch control of the liquid crystal panel.

In another aspect, a liquid crystal display apparatus having a liquid crystal panel mentioned above is provided.

In another aspect, a manufacturing method for a liquid crystal panel is also provided, including:

providing a substrate, wherein the substrate including a display region and a non-display region disposed at the periphery of the display region;

forming a plurality of color resist modules arranged in a matrix;

adding a conductive polymer in the material of the color resist to form a coating material of a planarization layer;

applying a layer of the planarization layer coating material on the display region to integrally to form the planarization layer, wherein the planarization layer including a shielding layer and a plurality of the first color resist connected to the shielding layer, the plurality of the first color resist and the plurality of the color resist modules are alternately arranged; the shielding layer is covering the plurality of the color resist modules to form a color filter substrate;

a sealant added with the conductive particles is formed on the non-display region, the sealant is connected to the planarization layer; and

providing an array substrate, align the array substrate and the color filter substrate, and makes the sealant connected to the grounding pad of the array substrate to form the liquid crystal layer.

Wherein the conductive polymer including 3,4-ethylenedioxythiophene, PEDOT.

Wherein the conductive particles including gold balls and/or copper particle.

Comparing to the conventional technology, the present application has the following advantage:

The liquid crystal panel of the present embodiment, by the design of the planarization layer added with the conductive polymer, the sealant added with conductive particles, and the sealant connected to the planarization layer and the grounding pad of the array substrate, therefore the planarization layer is grounded. When the external electrostatic exposes to the liquid crystal panel, the electrostatic charges can be quickly released to the ground by the planarization layer and the sealant to avoid the static electricity damage to the liquid crystal panel caused by the outside static electricity.

### BRIEF DESCRIPTION OF THE DRAWINGS

In order to more clearly illustrate the embodiments of the present application or prior art, the following figures will be described in the embodiments are briefly introduced. It is obvious that the drawings are merely some embodiments of the present application, those of ordinary skill in this field can obtain other figures according to these figures without paying the premise.

FIG. 1 illustrates a schematic structure of a liquid crystal panel of the embodiment of the present application; and

FIGS. 2-6 illustrate the schematic structures corresponding to each steps for manufacturing the liquid crystal panel of the embodiment of the present application.

### DETAILED DESCRIPTION OF PREFERRED EMBODIMENTS

Embodiments of the present application are described in detail with the technical matters, structural features, achieved objects, and effects with reference to the accompanying drawings as follows. It is clear that the described embodiments are part of embodiments of the present application, but not all embodiments. Based on the embodiments of the present application, all other embodiments to those of ordinary skill in the premise of no creative efforts obtained should be considered within the scope of protection of the present application.

Specifically, the terminologies in the embodiments of the present application are merely for describing the purpose of the certain embodiment, but not to limit the invention. Examples and the claims be implemented in the present application requires the use of the singular form of the book “an”, “the” and “the” are intend to include most forms unless the context clearly dictates otherwise. It should also be understood that the terminology used herein that “and/or” means and includes any or all possible combinations of one or more of the associated listed items.

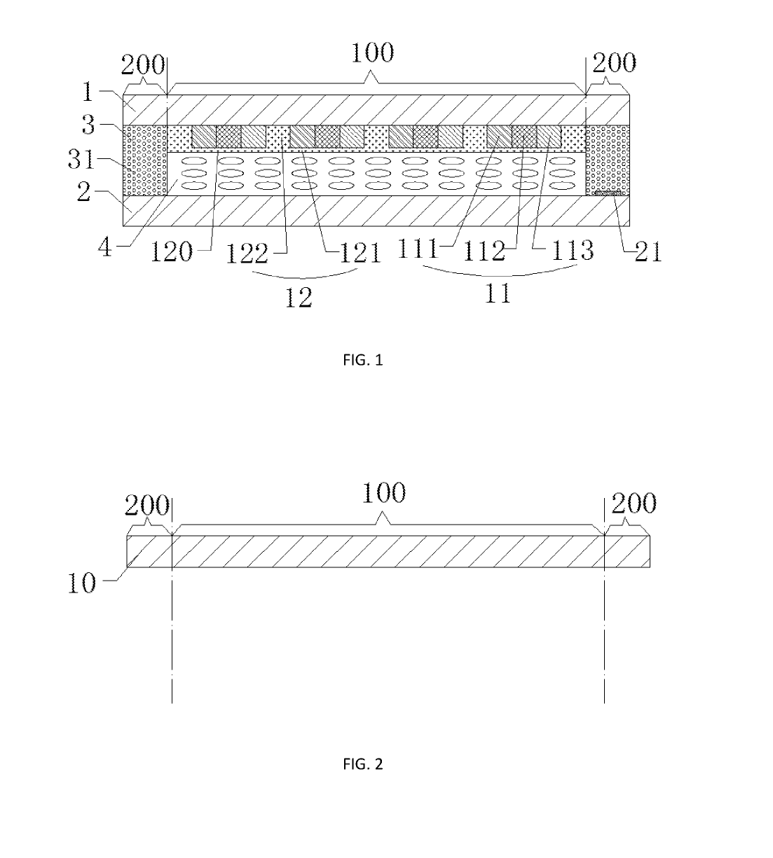

Referring to FIG. 1, a liquid crystal panel is provided in the embodiment of the present application including a color filter substrate 1, an array substrate 2, a sealant 3 and a liquid crystal layer 4. Wherein the color filter substrate 1 forms a display region, 100 and a non-display region 200 disposed at the periphery of the display region 100. The color filter substrate 1 includes a plurality of color resist modules 11 and a planarization layer, the plurality of color resist modules 11 is arranged in a matrix within the display region 100. The planarization layer 12 includes a shielding layer 121 and a plurality of the first color resist 122 connected to the shielding layer 121. The plurality of the first color resist 122 and the plurality of the color resist modules 11 are alternately arranged in the display region 100. The shielding layer 121 is covering the plurality of the color resist modules 11, the planarization layer 12 has a conducting polymer 120. The array substrate 2 is disposed opposite to the color filter substrate 1. The array substrate 2 includes a grounding pad 21 disposed facing to the non-display region 200. The sealant 3 is connected to the array substrate 2 and the non-display region 200 of the color filter substrate 1, to seal and hold the liquid crystal layer 4 between the color filter substrate 1 and the array substrate 2, a conductive particle 31 is added in the sealant 3 and the sealant 3 is connected to the planarization layer 12 and the grounding pad 21 to make the planarization layer 12 connecting to ground.

In the present embodiment, the conducting polymer 120 is added in the planarization layer 12 of the liquid crystal layer. A conductive particle 31 is added in the sealant 3, and the sealant 3 is connected to the planarization layer 12 and the grounding pad 21 of the array substrate 2, therefore the planarization layer 12 connecting to ground. Since the shielding layer 121 of the planarization layer 12 is connected to the plurality of first color resist 122 and covering the plurality of color resist modules 11, therefore the planarization layer 100 covers the display region 100. When the external electrostatic exposes to the liquid crystal panel, the electrostatic charges can be quickly released to the ground by the planarization layer 12 and the sealant 3 to avoid the static electricity damage to the liquid crystal panel caused by the outside static electricity. Meanwhile, since the planarization layer 12, the sealant 3 and the grounding pad 21 are all located between the array substrate 1 and the color filter substrate 2, with a strong connection between each other, and difficult to damage, so the liquid crystal panel has a reliable static electricity protection performance. Further, since the plurality of the first color resists 122 of the planarization layer 12 is involved in the display function of the liquid crystal panel. When the planarization layer 12 is formed within the liquid crystal panel, the additional space occupied by the planarization layer 12 is small, and is contributed to the miniaturization of the liquid crystal panel and the development of thinner.

It should be understood that the color resist material is adapted as the base of the planarization layer 12 and the conductive polymer 120 is added in the base to make the planarization layer 12 having conductivity. Meanwhile, since the planarization layer 12 is disposed between the color filter substrate 1 and the array substrate 2, thus reducing the scratching damage risk of the planarization layer 12, and the hardness requirement of the color resist material adapted by the planarization layer 12 cane be lower appropriately. So the range to choose the color resist material is broader. The silver adhesive adding process is reduced, and improves production efficiency.

Referring to FIG. 1, in the present embodiment, the “alternate arrangement” means in a single direction, the plurality of the color resist modules 11 and the plurality of the first color resist 122 are alternately arranged, e.g., the alternately arrangement of “one color resist modules 11—one first color resist 122—one color resist modules 11—one first color resist 122” in an alternating manner. In this case, the present embodiment is not limited the arrangement of the plurality of the color resist modules 11 and the plurality of the first color resist 122 in another direction vertical to the single direction.

It can be applied to the needs of specific application to arrange as “one color resist modules 11—one first color resist 122—one color resist modules 11—one first color resist 122” in an alternating fashion, or “one color resist modules 11—one color resist modules 11—one first color resist 122—one first color resist 122” in a repetitive manner.

Further, Referring to FIG. 1, optionally, each of the color resist modules 11 includes a second color resist 111, a third color resist 112 and a fourth color resist 113. Wherein the second color resist 111 is red color resist (R, red), the third color resist 112 is green color resist (G, green), the fourth color resist 113 is blue color resist (B, blue), the plurality of first color resist 122 is white color resist (W, white) or yellow color resist (Y, yellow). Thus, when the plurality of the first color resist 122 is white color resist, the liquid crystal panel in the present embodiment uses the RGBW display technology; when the plurality of first color resist 122 is yellow color resist, the liquid crystal panel in the present embodiment uses the RGBY display technology.

It can be understood that the planarization layer 12 in this embodiment can have the electrostatic shielding function, but also combined to the RGB color resist to achieve the RGBW or RGBY display of the liquid crystal display and make the liquid crystal display having a high color gamut, low-power performance.

In the present embodiment, the second color resist 111, the third color resist 112 and the fourth color resist 113 are arranged sequentially connected. It should be understood that, in other embodiments, the second color resist 111, the third color resist 112 and the fourth color resist 113 can also have other arrangement manner.

Further, referring to FIG. 1, optionally, the shielding layer 121 can cover the plurality of the color resist modules 11 and the plurality of the first color resist 122, i.e. the shielding layer 121 can be formed of a complete coverage, and to cover the display region 100. In this case, the connection relationship between the shielding layer 121 and the plurality of the first color resist 122 are more reliable. And the surface of the shielding layer 121 toward to the liquid crystal layer 4 can also have a very good flatness in order to facilitate the subsequent process, improving the yield of the liquid crystal panel.
Further, optionally, the conductive polymer 120 includes 3,4-ethylenedioxythiophene, PEDOT, of course, in other embodiments, the conductive polymer 120 can be any other material having electrically conductive properties.

Further, optionally, the conductive particles 31 include gold balls and/or copper particle. Of course, in other embodiments, the conductive particles 31 can be any other material having electrically conductive properties.

Further, optionally, a touch sensor (not shown) is integrated on the array substrate 2 to realize the touch control of the liquid crystal panel. That is, the liquid crystal panel of the present embodiment can be an in-cell touch panel.
A liquid crystal display apparatus is also provided in the embodiments of the present invention, includes the liquid crystal panel described in in any of the embodiments mentioned above. Since the adaption the liquid crystal panel described above, the liquid crystal display apparatus of the present embodiment has a reliable static electricity protection performance. In particular, the liquid crystal display apparatus is a touch-type liquid crystal display apparatus.
Referring to FIGS. 2-6, a manufacturing method for a liquid crystal panel is also provided in the present application includes:

Step 1: providing a substrate 10, the substrate 10 includes a display region 100 and a non-display region 200 disposed at the periphery of the display region 100, as illustrated in FIG. 2.

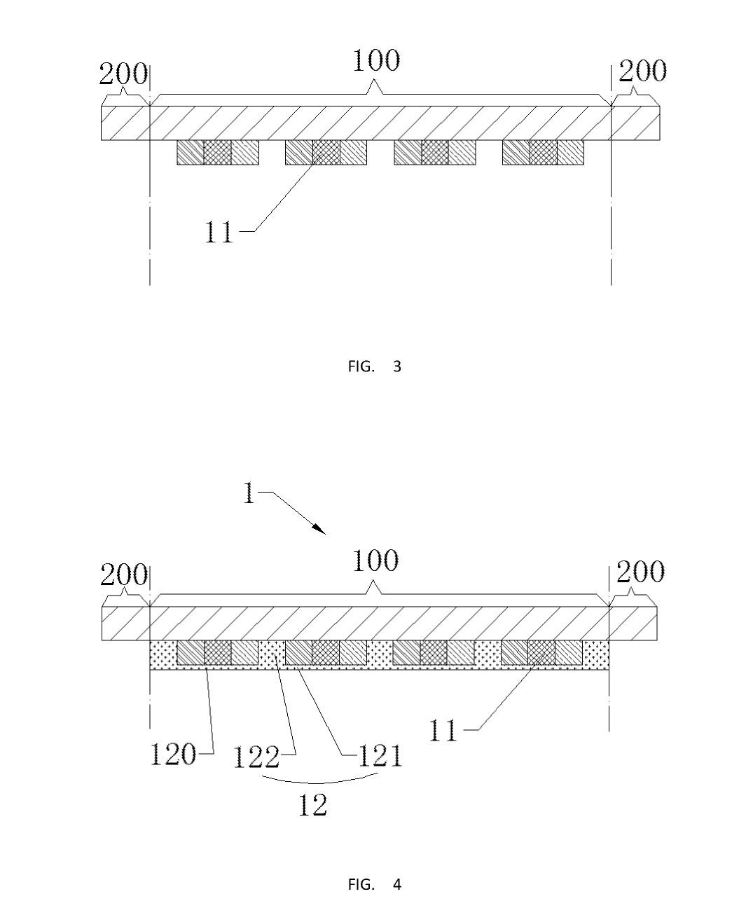

Step 2: a plurality of color resist modules 11 arranged in a matrix is formed on the display region 100, as illustrated in FIG. 3.

Step 3: a planarization layer 12 added with a conductive polymer 120 is formed on the display region 100. The planarization layer 12 includes a shielding layer 121 and a plurality of the first color resist 122 connected to the shielding layer 121. The plurality of the first color resist 122 and the plurality of the color resist modules 11 are alternately arranged, the shielding layer 121 covering the plurality of color resist modules 11 to form a color filter substrate 1, as illustrated in FIG. 4.

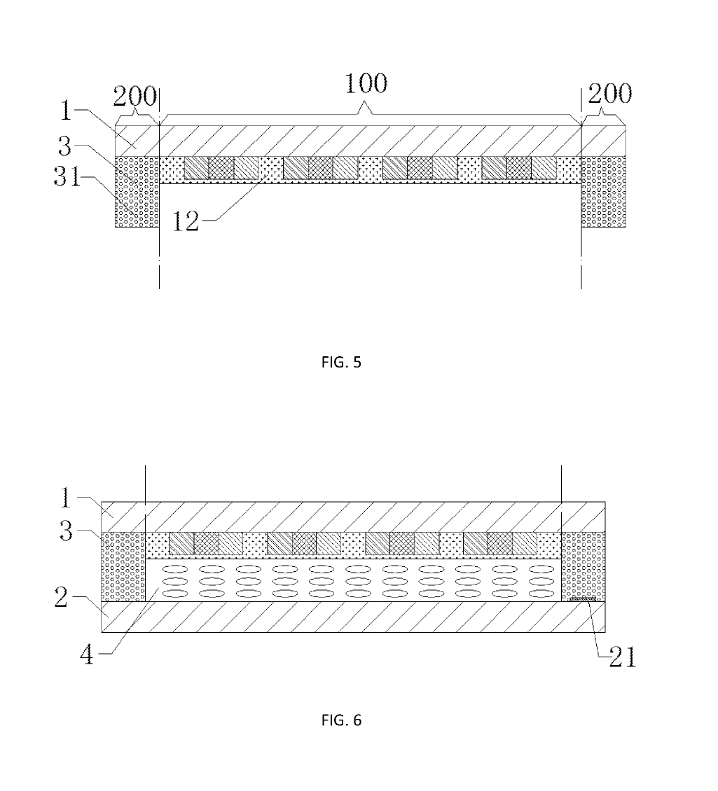

Step 4: a sealant 3 added with the conductive particles 31 is formed on the non-display region 200, the sealant 3 is connected to the planarization layer 12, as illustrated in FIG. 5; and

Step 5: an array substrate 2 is provided, the align the array substrate 2 and the color filter substrate 1 and makes the sealant 3 connected to the grounding pad 21 of the array substrate 2. A liquid crystal layer 4 is filled in the space provided by the color filter substrate 1, the array substrate 2, and the sealant 3 to form a liquid crystal panel, as illustrated in FIG. 6.

Further, referring to FIG. 4, the description of “a planarization layer 12 added with a conductive polymer 120 is formed on the display region 100” in the step 3 includes:

Step 31: Adding a conductive polymer 120 in the color resist material to form a coating material of the planarization layer 12;

Step 32: applying a layer of the planarization layer coating material on the display region 100 to form the plurality of first color resist 122 and the shielding layer 121 integrally to form the planarization layer 12.

The liquid crystal panel formed by the manufacturing method of the present embodiment, the planarization layer 12 is added with the conductive polymer 120, the sealant 3 is added with conductive particles 31, and the sealant 3 is connected to the planarization layer 12 and the grounding pad 21 of the array substrate 2, therefore the planarization layer 12 is grounded. Since the shielding layer 121 of the planarization layer 12 is connected to the plurality of first color resist 122 and covering the plurality of color resist modules 11, therefore the planarization layer 100 covers the display region 100. When the external electrostatic exposes to the liquid crystal panel, the electrostatic charges can be quickly released to the ground by the planarization layer 12 and the sealant 3 to avoid the static electricity damage to the liquid crystal panel caused by the outside static electricity.

In the present embodiment, the planarization layer 12 is formed integrally, the same material is used in the plurality of first color resist 122 of the shielding layer 121, to reduces the material types involved in the manufacturing method of the liquid crystal panel, and the process is simplified to achieve process optimization.

It should be understood that, since the process of forming the planarization layer 12 is integrated in the process of forming the color filter substrate 1, therefore the preparation of liquid crystal panel can be optimized to improve the productivity of the liquid crystal panel.

Further, optionally, the conductive polymer 120 includes 3,4-ethylenedioxythiophene, PEDOT, the conductive particles include gold ball 31 and/or copper particle.

Above are embodiments of the present application, which does not limit the scope of the present application. Any modifications, equivalent replacements or improvements within the spirit and principles of the embodiment described above should be covered by the protected scope of the invention.

What is claimed is:

1. A liquid crystal panel, comprising:
a color filter substrate forms a display region and a non-display region disposed at the periphery of the display region; the color filter substrate comprising a plurality of color resist modules and a planarization layer, the plurality of color resist modules is arranged in a matrix within the display region, the planarization layer comprising a shielding layer and a plurality of the first color resist connected to the shielding layer, the plurality of the first color resist and the plurality of the color resist modules are alternately arranged in the display region, the shielding layer is covering the plurality of the color resist modules, a conducting polymer is added in the planarization layer;
an array substrate disposed opposite to the color filter substrate, the array substrate comprising a grounding pad disposed facing to the non-display region; and
a sealant connected to the array substrate and the non-display region to seal and hold a liquid crystal layer between the color filter substrate and the array substrate, a conductive particle is added in the sealant and the sealant is connected to the planarization layer and the grounding pad to make the planarization layer connecting to ground.

2. The liquid crystal panel according to claim 1, wherein each of the color resist modules comprising a second color resist, a third color resist and a fourth color resist, wherein the second color resist is red color resist, the third color resist is green color resist, the fourth color resist is blue color resist and the plurality of first color resist is white color resist or yellow color resist.

3. The liquid crystal panel according to claim 1, wherein the shielding layer covered the plurality of the color resist modules and makes the shielding layer covered the planarization layer.

4. The liquid crystal panel according to claim 1, wherein the conductive polymer comprising 3,4-ethylenedioxythiophene, PEDOT.

5. The liquid crystal panel according to claim 1, wherein the conductive particles comprising gold balls and/or copper particle.

6. The liquid crystal panel according to claim 1, further comprising a touch sensor integrated on the array substrate to realize the touch control of the liquid crystal panel.

7. A liquid crystal display apparatus having a liquid crystal panel, wherein the liquid crystal panel comprising:
a color filter substrate forms a display region and a non-display region disposed at the periphery of the display region; the color filter substrate comprising a plurality of color resist modules and a planarization layer, the plurality of color resist modules is arranged in a matrix within the display region, the planarization layer comprising a shielding layer and a plurality of the first color resist connected to the shielding layer, the plurality of the first color resist and the plurality of the color resist modules are alternately arranged in the display region, the shielding layer is covering the plurality of the color resist modules, a conducting polymer is added in the planarization layer;
an array substrate disposed opposite to the color filter substrate, the array substrate comprising a grounding pad disposed facing to the non-display region; and
a sealant connected to the array substrate and the non-display region to seal and hold a liquid crystal layer between the color filter substrate and the array substrate, a conductive particle is added in the sealant and the sealant is connected to the planarization layer and the grounding pad to make the planarization layer connecting to ground.

8. The liquid crystal display apparatus according to claim 7, wherein each of the color resist modules comprising a second color resist, a third color resist and a fourth color resist, wherein the second color resist is red color resist, the third color resist is green color resist, the fourth color resist is blue color resist and the plurality of first color resist is white color resist or yellow color resist.

9. The liquid crystal display apparatus according to claim 7, wherein the shielding layer covered the plurality of the color resist modules and makes the shielding layer covered the planarization layer.

10. The liquid crystal display apparatus according to claim 7, wherein the conductive polymer comprising 3,4-ethylenedioxythiophene, PEDOT.

11. The liquid crystal display apparatus according to claim 7, wherein the conductive particles comprising gold balls and/or copper particle.

12. The liquid crystal display apparatus according to claim 7, further comprising a touch sensor integrated on the array substrate to realize the touch control of the liquid crystal panel.

13. A manufacturing method for a liquid crystal panel, comprising:
providing a substrate, wherein the substrate comprising a display region and a non-display region disposed at the periphery of the display region;
forming a plurality of color resist modules arranged in a matrix;
adding a conductive polymer in the material of the color resist to form a coating material of a planarization layer;
applying a layer of the planarization layer coating material on the display region to integrally to form the planarization layer, wherein the planarization layer comprising a shielding layer and a plurality of the first color resist connected to the shielding layer, the plurality of the first color resist and the plurality of the color resist modules are alternately arranged; the shielding layer is covering the plurality of the color resist modules to form a color filter substrate;
a sealant added with the conductive particles is formed on the non-display region, the sealant is connected to the planarization layer; and
providing an array substrate, align the array substrate and the color filter substrate, and makes the sealant connected to the grounding pad of the array substrate to form the liquid crystal layer.

14. The manufacturing method for a liquid crystal panel according to claim 13, wherein the conductive polymer comprising 3,4-ethylenedioxythiophene, PEDOT.

15. The manufacturing method for a liquid crystal panel according to claim 13, wherein the conductive particles comprising gold balls and/or copper particle.
